(19) United States
(12) Patent Application Publication
(10) Pub. No.: US 2013/0177155 A1
(43) Pub. Date: Jul. 11, 2013

(54) Method and System for Generating Normal Distributed Random Variables Based On Cryptographic Function

(71) Applicant: Comtech EF Data Corp., Tempe, AZ (US)

(72) Inventors: Kasra Akhavan-Toyserkani, Bethesda, MD (US); John Youssef, Bethesda, MD (US); Cris Mamaril, Mesa, AZ (US)

(73) Assignee: COMTECH EF DATA CORP., Tempe, AZ (US)

(21) Appl. No.: 13/781,466

(22) Filed: Feb. 28, 2013

Related U.S. Application Data
(60) Provisional application No. 61/710,225, filed on Oct. 5, 2012.

(51) Int. Cl. H04L 9/28

(52) U.S. Cl. CPC H04L 9/28
USPC 380/255

(57) ABSTRACT

A method of generating normally distributed random variables for communication channel simulation comprising generating, by a processor, a stream of uniformly distributed random variables using a cryptographic algorithm, applying a mathematical transform to the uniformly distributed random variables using the processor to create a signal comprised of normally distributed random variables, adjusting a mean and variance of the signal using the processor, and outputting, by the processor, an output noise signal.

### CROSS REFERENCE TO RELATED APPLICATIONS

This document claims the benefit of the filing date of U.S. Provisional Patent Application No. 61/710,225, entitled “Method and System for Generating Normal Distributed Random Variable Based on Cryptographic Function” to Kasra Akhavan-Toyserkani, et al., which was filed on Oct. 5, 2012,the disclosure of which is hereby incorporated entirely by reference herein.

### BACKGROUND

1. Technical Field

Aspects of this document relate generally to telecommunication systems and techniques for transmitting data across a telecommunication channel.

2. Background Art

In the existing art, normally distributed random variable (RV) samples are generated by first generating a uniform distributed random variable using a Pseudo-Random Number Generator (PRNG) based on well-known techniques using Linear Feedback Shift Registers (LFSR) and then applying one of many available mathematical transforms, such as for example, Box Muller, Central Limit Theorem (Sum-of-Uniforms), Piecewise Linear Approximation using Triangular distribution, Monty Python Method, Recursive Method (Wallace), Ziggurat Method, Inversion Method, etc. to generate the normally distributed RV from the uniform distributed RV. Although there are now many hardware implementations of algorithms that can accurately perform the transformation from a uniform to a normally distributed RV, the accuracy of the normal distribution is still limited by the accuracy of the method for generating the uniformly distributed samples. The traditional method of using LFSR does not produce accurate uniform random variables because of its relatively short periodicity, which limits the accuracy at the tail of the normal distribution. Although techniques have been implemented to mitigate this effect by extending the periodicity of a particular LFSR, these techniques still impose limitations on the accuracy of the normal probability distribution function generated.

As an alternative to digital implementations of uniform distributed random variables, there are also analog methods present in the current art. These analog methods rely on errors in analog components to generate true random numbers, but these methods are sensitive to environmental changes such as temperature, and also cannot support high throughput applications.

### SUMMARY

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Description , Drawings, or Claims is not intended to somehow indicate a desire to invoke the special provisions of 35 U.S.C. §112, ¶6, to define the invention. To the contrary, if the provisions of 35 U.S.C. §112, ¶6 are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 depicts a traditional method of generating normally distributed random variables as disclosed by the prior art.

FIG. 2 shows an implementation of a method of generating normally distributed random variables using a cryptographic algorithm.

FIG. 3 shows an implementation of a method of generating Additive White Gaussian Noise (AWGN) for an exemplary cryptographic algorithm and mathematical transform.

FIGS. 4-5 show implementations of a method of generating AWGN using a cryptographic algorithm and mathematical transform and digitally combining the AWGN with a data signal at baseband.

FIG. 6 shows an implementation of a method of generating AWGN using a cryptographic algorithm and mathematical transform for external combination with a data signal.

### DESCRIPTION

This disclosure, its aspects and implementations, are not limited to the specific components, encryption types, or methods disclosed herein. Many additional components and assembly procedures known in the art consistent with a method for generating normalized random variables are in use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

This disclosure relates generally to a method for generating normally distributed random variables for a communications channel and other application. More specifically, this disclosure relates to a method and system for providing highly accurate normally distributed random variable samples based on the application of one or more cryptographic algorithms. Implementations of the described method and system offer a novel approach for providing high quality and accurate normally distributed random variables. Particular implementations described herein may use but are not limited to using techniques for cryptography and/or digital signal processing (DSP) techniques such as, but not limited to, multiplication, square-root, log, cosine/sine look-up table, encryption/decryption, that may be implemented in devices such as a Field-Programmable Gate Array (FPGA), Programmable Logic Device (PLD), Programmable Integrated Circuit (PIC), Digital Signal Processor (DSP), Application Specific Integrated Circuit (ASIC) or general purpose microprocessors using conventional implementation methods known in the art with knowledge of this disclosure.

The described implementations are intended to provide one of ordinary skilled in the art, e.g., a communications software or hardware engineer, and the like to utilize the described methodology without undue experimentation.

In the existing art, digital implementations of systems and methods for generating normally distributed random variables rely on various Linear Feedback Shift Register (LFSR) techniques that produce pseudorandom numbers that do not have the statistical quality of a cryptographic algorithm, such as an Advanced Encryption Standard (AES), and which tend to repeat after a relatively short period. The LFSR based techniques are used to generate uniformly distributed random variables which are then transformed mathematically into normally distributed random variables. A short periodicity, such as that present when using LFSR techniques has a negative impact on the resulting output due to the lack of true randomness. Thus, the quality and accuracy of the normally distributed random variables is limited to the quality of the uniformly distributed random variables which are input into the mathematical transformation. The quality of the normally distributed random variables is evaluated as the probability distribution function quality in the tails as expressed in a maximum attainable multiple of the standard deviation. In implementations of the described method and system, a cryptographic algorithm is used to generate more accurately uniformly distributed random samples rather than those generated through the use of LFSR.

In implementations of the described method and system, higher quality and more accurate normally distributed random variables can be generated by replacing the LFSR with a cryptographic algorithm, such as Advanced Encryption Standard (AES) in Cyclic Block Cipher (CBC) mode. The AES in CBC mode runs freely and generates a stream of pseudorandom numbers having higher entropy and without the relatively short periodicity issue associated with LFSR as used in traditional methodologies. Implementations of the described method can also be efficiently implemented and realized digitally in hardware. This provides for high throughput applications and does not have the instability of analog based implementations.

In implementations of the described method, cryptographic algorithms, such as AES in CBC mode, is used to generate uniform distributed RV with better statistical properties (i.e. higher entropy) and significantly longer period than required for most applications. One of the advantages of using cryptographic algorithms is to remove correlation from a given input data set and generating randomness. Particular modes of operation, such as CBC, allow a cryptographic algorithm to free-run and continuously generate random data even when an input value is held constant by using the cipher output for the previous block and applying the XOR operation with the input In other words, implementations of the disclosed method can continue to generate random samples without the relatively short periodicity limitation associated with LFSR. Thus, implementations of the disclosed methods generate a significantly higher quality random number stream and when combined with a transformation algorithm, such as Box Muller or any other transformation algorithm known to those of ordinary skill in the art, may yield a far more accurate normal distribution of random variable samples that more closely emulate a true normal probability distribution function (PDF). Furthermore, digital implementations of the disclosed method do not suffer from the drawbacks of traditional analog methods such as parameter or component drift, temperature sensitivity or lack of repeatability to name a few examples.

Generation of random variables with a normal probability distribution has utility in many applications. For example, one such application is the implementation of an Additive White Gaussian Noise (AWGN) Generator for simulating a noisy communication channel, such as, for example, in a satellite link. The AWGN is a specific case of a normal distributed random variable with a mean equal to zero and a noise power equal to the variance. Implementations of the described method provide a novel approach for generating normally distributed random variables based on certain advanced cryptographic algorithms, such as for example, Advanced Encryption Standard (AES) in Cyclic Block Cipher (CBC) mode.

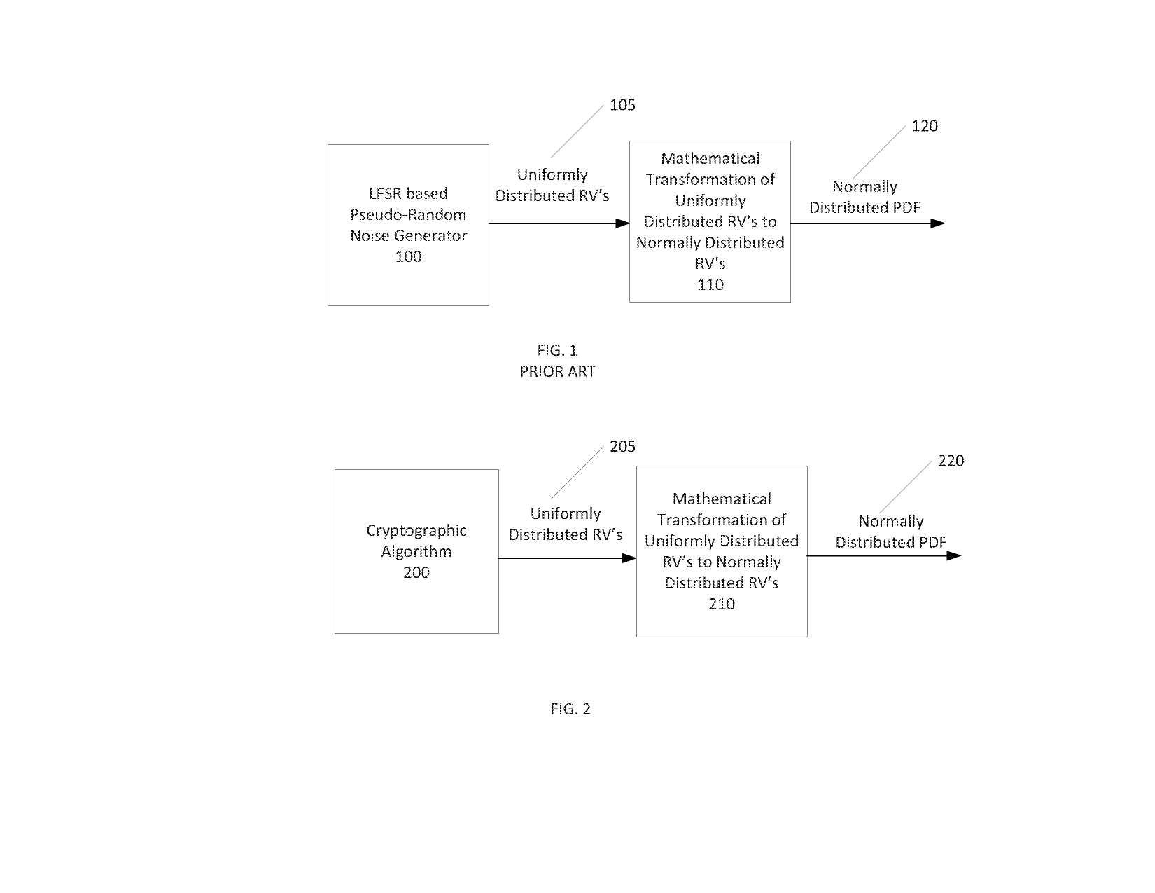

FIG. 1 shows an implementation of a traditional method of generating normally distributed random variables as disclosed by the prior art. As one of ordinary skill in the art is aware, using currently known methodologies, a pseudo-random number generator (PRNG) utilizes known techniques using one or more linear feedback shift registers (LFSR) 100 to generate uniformly distributed random variables 105. A known mathematical transformation is then performed by a processor or other suitable hardware to transform the uniformly distributed random variables to normally distributed random variables 110 resulting in an output of a normally distributed probability distribution function 120.

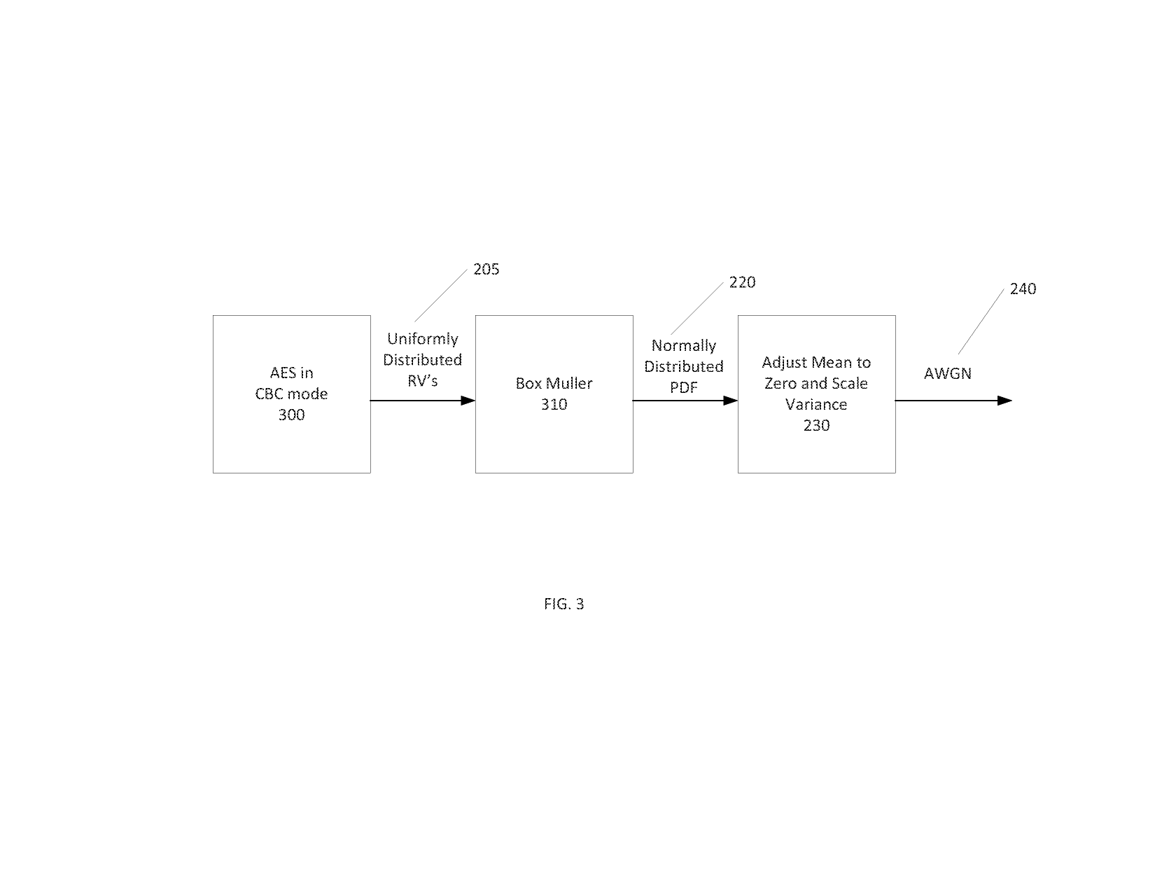

FIG. 2 shows an implementation of the described method that utilizes a cryptographic algorithm to generate normally distributed random variables. As shown, a processor or other appropriate hardware device applies a cryptographic algorithm 200 to generate uniformly distributed random variables 205. Such a cryptographic algorithm may comprise a block cipher, a stream cipher, or any other appropriate cryptographic cipher. A mathematical transformation is then applied to the uniformly distributed random variables to convert them to a normal distribution of random variables 210, thereby resulting in the output of a normally distributed probability distribution function 220 being output from the processor 220. Some examples of such a mathematical transformation may include, but are not limited to a Box Muller Method, Ziggurat Method, Inversion Method, and Wallace Method. Such an implementation produces a more truly random normalized distribution of variables due to the greater accuracy in creating a uniformly distributed random variable stream.

Particular implementations of a method for generating accurate normalized random variable samples as disclosed herein may be specifically employed for the application of an Additive White Gaussian Noise (AWGN) generator to simulate communication channels. However, one of ordinary skill in the art will recognize from this disclosure that the principles and aspects disclosed herein may readily be applied any other application that requires accurate normal distributed random variables.

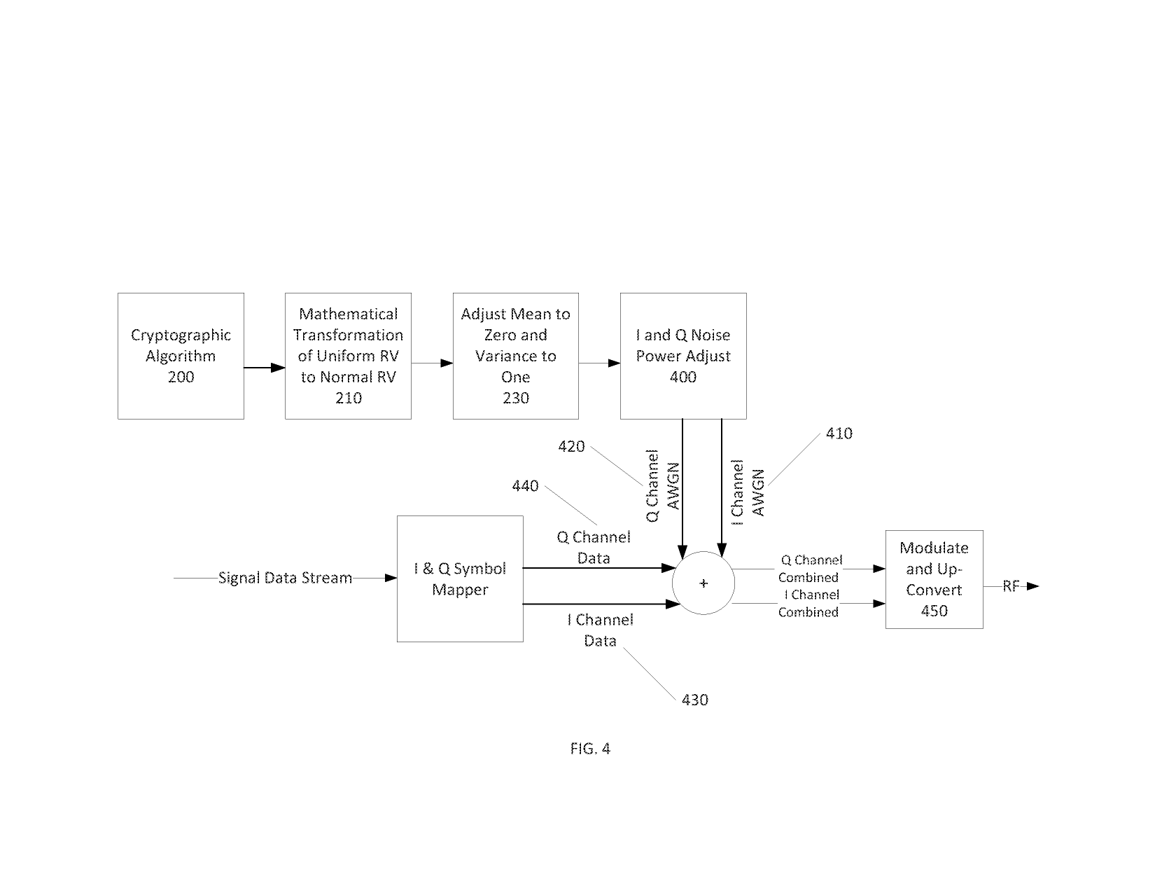

A more specific example of an implementation of the disclosed method in the application of an Additive White Gaussian Noise Generator (AWGN) is provided in FIG. 3. Here, as shown, the cryptographic algorithm used is a block cipher known as Advanced Encryption Standard (AES) operating in Cyclic Block Cipher (CBC) mode 300. A uniformly distributed stream of random variables 205 is output from the AES operating in CBC mode 300 and as shown here, a specific mathematical transform known in the art as the Box Muller method 310 is applied by the processor. This results in an output of a normally distributed probability distribution of random variables 220 which the processor then adjust the mean and variance 230 to create an output data signal comprised of Additive White Gaussian Noise (AWGN) 240.

In an implementation of the AWGN generator, using an implementation of the disclosed method, one may digitally tune and control the signal-to-noise level at baseband with a very high resolution and accuracy which provides a significant advantage compared to using methodologies present in the prior art.

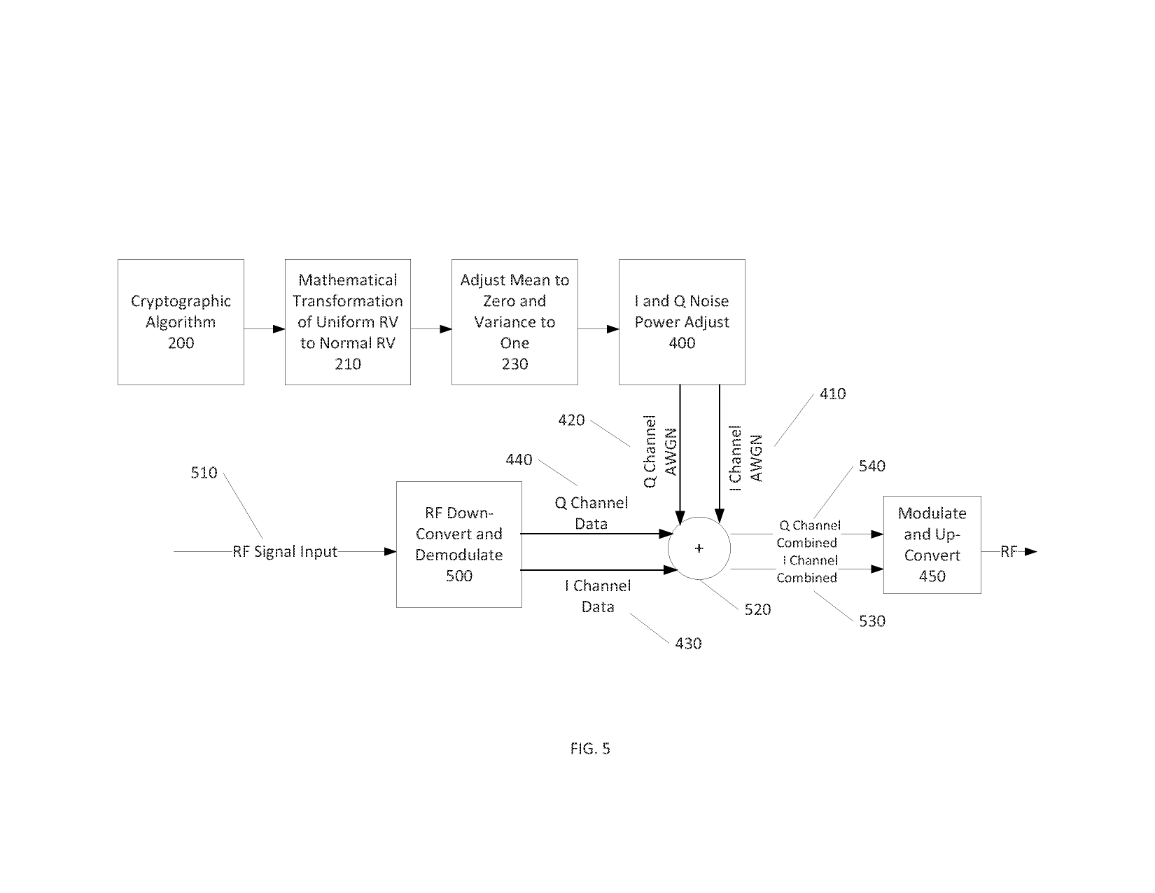

As described above, particular implementations of the described methods and systems apply to AWGN generators to simulate a communication channel, but the technology described is not limited to this application. It is also intended that implementations of the described methods may be built into a communication link transmitter in a single hardware device or among a plurality of hardware devices. For example, as shown in FIG. 4, a cryptographic device which includes any processing device as would be known to one of ordinary skill in the art may be used to apply the cryptographic algorithm and output uniformly distributed random variables which are transmitted to a discrete device that is separate from the cryptographic device that applies the mathematical transformation to convert the uniformly distributed random variables to AWGN. The AWGN data is then amplified or attenuated to achieve a particular noise power level 400. The AWGN I and Q samples 410, 420 are added to the signal I and Q symbols 430, 440 at complex baseband prior to modulating 450 and transmitting the combined signal to a remote receiver to simulate a communications channel. The ability to add noise 520 digitally at complex baseband provides the ability to tune the signal-to-noise ratio with much high precision and resolution than that which is available when utilizing current methodologies.

Depending upon the implementation, at least one of a cipher input data, a cipher input key, and/or an initialization vector (IV) may be held at a fixed constant value or may be dynamic and periodically changing.

However, in some applications, it may be advantageous to configure an implementation of the system to create a stand-alone device that creates AWGN or any other form of the normally distributed random variables disclosed herein and receives a data signal and combines the data signal with the AWGN or other noise signal created by the stand-alone device and transmits the combined data and noise signal, as shown in FIG. 5. While such applications may be used in any field, in a field such as satellite communications, implementations of this process may also involve the stand-alone noise generation device downconverting and demodulating 500 the received data signal 510 (in this example, a radio frequency (RF) signal) to baseband, digitally adding 520 the AWGN 410, 420 or other noise generated by the stand-alone device at baseband, modulating and upconverting 450 the combined I and Q symbols 530, 540 to RF for transmission. The signal-to-noise ratio can be controlled and set digitally with much higher precision and resolution than is available using methods and systems of the prior art.

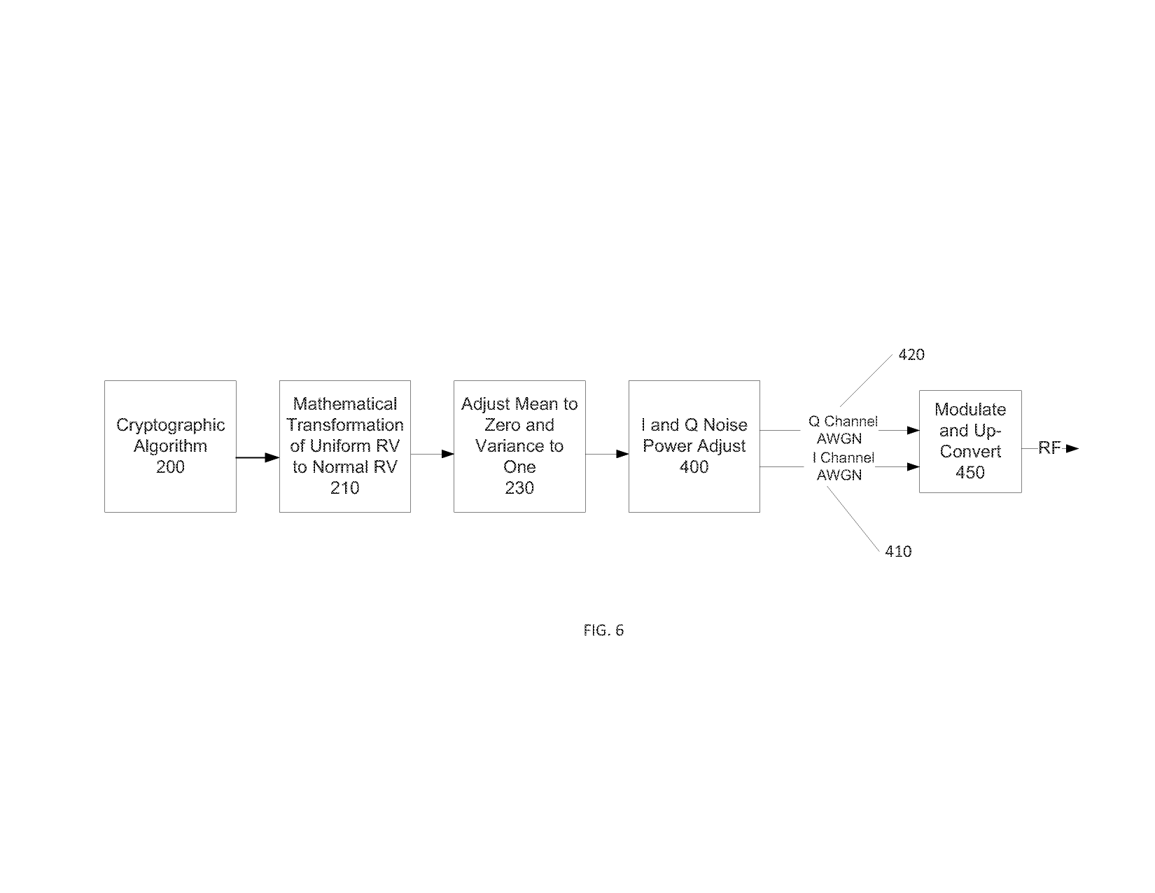

Furthermore, in some applications, it may be advantageous to configure an implementation of the system to create a stand-alone device that creates AWGN or any other form of the normally distributed random variables disclosed, as shown in FIG. 6. While such applications may be used in any field, in a field such as satellite communications, implementations of this process may also involve the stand-alone noise generation device to generate I and Q samples 410, 420, which are power adjusted 400, modulated and upconverted 450 to a radio frequency (RF) signal. In some implementations of this arrangement, a separate data signal and the noise signal may be combined externally at RF.

In some implementations, to achieve higher throughput, multiple cryptographic devices or multiple processors within a cryptographic device may be run in parallel.

In places where the description above refers to particular implementations of telecommunication systems and techniques for transmitting data across a telecommunication channel, it should be readily apparent that a number of modifications may be made without departing from the spirit thereof and that these implementations may be applied to other to telecommunication systems and techniques for transmitting data across a telecommunication channel.

1. A method of generating normally distributed random variables for communication channel simulation comprising:
generating, by a processor, a stream of uniformly distributed random variables using a cryptographic algorithm;
applying a mathematical transform to the uniformly distributed random variables using the processor to create a signal comprised of normally distributed random variables;
adjusting a mean and variance of the signal using the processor; and
outputting, by the processor, an output noise signal.

2. The method of claim 1, further comprising adjusting a power level of the output noise signal.

3. The method of claim 1, wherein the cryptographic algorithm comprises a block cipher.

4. The method of claim 3, wherein the block cipher comprises an advanced encryption standard (AES) in cyclic block cipher (CBC) mode.

5. The method of claim 1, wherein at least one of a cipher input data, a cipher input key, and an initialization vector (IV) comprises a constant fixed value that is without periodic fluctuation.

6. The method of claim 1, wherein at least one of a cipher input data, a cipher input key, and an initialization vector (IV) comprises a dynamic value that changes periodically.

7. The method of claim 1, further comprising:
adding the noise signal to a data signal at complex baseband; and
modulating and upconverting the combined signal for transmission.

8. The method of claim 1, wherein the cryptographic algorithm comprises a stream cipher.

9. The method of claim 1, wherein the mathematical transform comprises one of a Box Muller method, a Ziggurat method, an Inversion method, and a Wallace method.

10. The method of claim 1, wherein applying the mathematical transform further comprises generating additive white Gaussian noise (AWGN) by adjusting a mean of the normally distributed random variable to zero and a variance of the normally distributed random variables to one.

11. A system for generating normally distributed random variables for communication channel simulation comprising:
a processor configured to:
generate a stream of uniformly distributed random variables using a cryptographic algorithm;
apply a mathematical transform to the uniformly distributed random variables to create a signal comprised of normally distributed random variables;
adjusting a mean and variance of the signal; and
output an output noise signal.

12. The system of claim 11, wherein the processor is further configured to adjust a power level of the output noise signal.

13. The system of claim 11, wherein the cryptographic algorithm comprises a block cipher.

14. The system of claim 13, wherein the block cipher comprises an advanced encryption standard (AES) in cyclic block cipher (CBC) mode.

15. The system of claim 11, wherein at least one of a cipher input data, a cipher input key, and an initialization vector (IV) comprises a constant fixed value that is without periodic fluctuation.

16. The system of claim 11, wherein at least one of a cipher input data, a cipher input key, and an initialization vector (IV) comprises a dynamic value that changes periodically.

17. The system of claim 11, wherein the processor is further configured to add the noise signal to a data signal at complex baseband and the system further comprises a modulator configured to modulate and upconvert the combined signal for transmission.

18. The system of claim 11, wherein the cryptographic algorithm comprises a stream cipher.

19. The system of claim 11, wherein the mathematical transform comprises one of a Box Muller method, a Ziggurat method, an Inversion method, and a Wallace method.

20. The system of claim 11, wherein the processor is further configured to generating additive white Gaussian noise (AWGN) by adjusting a mean of the normally distributed random variable to zero and a variance of the normally distributed random variables to one while applying the mathematical transform.
